(19) United States
(12) Patent Application Publication
(10) Pub. No.: US 2014/0319068 A1
(43) Pub. Date: Oct. 30, 2014

(54) METHODS FOR TREATING METALS AND METALLOIDS

(71) Applicant: KEMIRA OYJ, Helsinki (FI)

(72) Inventors: Anna Casasus, Norcross, GA (US); Fredrick Vance Fredrick Vance, Woodstock, GA (US)

(21) Appl. No.: 13/869,254

(22) Filed: Apr. 24, 2013

(51) Int. Cl. C02F 1/52

(52) U.S. Cl. CPC C02F 1/5254; C02F 1/5245
USPC 210/724; 210/702

(57) ABSTRACT

Methods of treating a liquid having a contaminant, compositions, and the like, are provided.

### BACKGROUND

The present embodiment(s) relate(s) to compositions and methods of treating contaminants, such as metals and metalloids.

One of the major problems facing industries such as municipal and industrial water, mining, and energy industries is removal of contaminants (e.g., selenium) from waste generated by these industries. Federal, state, and local standards for the maximum level of pollutants are becoming more stringent.

### SUMMARY

In view of the foregoing, one or more embodiments include a method of removing a contaminant from a material.

At least one embodiment provides a method of removing Se from a liquid, comprising: precipitating out a solid material including Se from the liquid by changing the pH of the liquid to about 10 to 12 with the addition of a base, wherein a metal is not separately added to the liquid, wherein the metal is selected from the group consisting of: Fe, Al, Ti, Cu, and Mn; and separating the solid material from the liquid.

At least one embodiment provides a method of removing Se from a liquid, comprising: precipitating out a solid material including Se from the liquid by changing the pH of the liquid to a pH of about 10 to 12 with the addition of a base, wherein a removing metal added to the liquid is present in the liquid at a concentration of less than about 5000 ppm, wherein the removing metal is selected from the group consisting of: Fe, Al, Ti, Cu, and Mn; and separating the solid from the liquid.

### BRIEF DESCRIPTION OF THE DRAWINGS

Many aspects of this disclosure can be better understood with reference to the following drawings.

FIG. 1 illustrates a graph that summarizes the results of experimentation investigating selenium removal by pH adjustment with NaOH followed by filtration.

### DETAILED DESCRIPTION OF THE EMBODIMENTS

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, metallo-organic chemistry, and the like, which are within the skill of the art. Such techniques are explained fully in the literature.

The examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms and phrases that shall be defined to have the following meanings unless a contrary intention is apparent.

In various exemplary embodiments described herein, methods of removing a contaminant by treating a liquid (e.g., a sample, which can include an entire batch or large quantity) and the like are provided. An exemplary embodiment of the present disclosure may be advantageous since the method can be efficient and can reduce capital costs that may be associated with currently used techniques.

In an exemplary embodiment, a method includes removing a contaminant (e.g., selenium) from a liquid by precipitating out a solid material including the contaminant from the liquid by changing the pH of the liquid to a pH of about 10 to 12, about 11 to 12, 10 to 12, or 11 to 12, with the addition of a base. In an embodiment, the liquid can be held at the desired pH for about 30 minutes to 24 hours. Subsequently, the method can optionally include removing the solid material from the liquid.

In an exemplary embodiment, the liquid may include one or more types of selenium contaminants and these may include elemental selenium, selenite, selenate, selenide, and/or selenite, based contaminants, or a combination thereof (e.g., types of compounds or complexes). In an embodiment, the selenium contaminant can be a selenite based contaminant.

In an exemplary embodiment, the liquid can be from or derived from: water from flue gas treatment, a mine, an industrial or municipal water treatment center, an oil processing or refining center, a coal processing center or plant, a smelting center, a disposal or incineration center, a non-ferrous metal processing center, a semiconductor fabrication center, mine water runoff (e.g., such as leachate from a tailings holding site, or mine dewatering), waste water stream from a coal-fired power plant, aqueous mixtures from one or more of any of the forgoing, and the like, as well as aqueous mixtures of one or more of: sludge, coal waste, coal ash, or the like. In an embodiment, the liquid is flue gas desulfurization (FGD) blowdown water.

According to the various embodiments, the steps of the method can be varied or modified, as necessary or desired, to accommodate various process conditions such as, for example, the type of liquid, the type(s) of contaminant in the liquid, the amount of contaminant present in the liquid, the pH of the liquid, and the like.

In an embodiment, a metal (e.g., metal-containing compound like metal salts or metal complex) is not independently added (e.g., added to the liquid outside of the normal processes that the liquid is used) to the liquid to cause removal of selenium contaminants. In contrast, other methods for removing contaminants involve independently adding metals (e.g., metal compounds, to use in co-participation or as absorbing metals) to facilitate removal of a contaminant from the liquid. In an embodiment, the liquid may include metals as a consequence of the environment in which the liquid is used and/or the processes that involve the use of the liquid. However, in an embodiment, other removing metals (e.g., metal compounds such as those to cause selenium to separate from the liquid) are not independently added to the liquid prior to the method of removing the contaminant. In an embodiment, the removing metal can include the following: Fe, Al, Ti, Cu, and Mn, as well as compounds and complexes that may include these metals.

In an embodiment, the base can include hydroxides of ammonium and alkali hydroxides (e.g., Group 1 and 2 alkalis and earth alkalis such as sodium, potassium, lithium, calcium, cesium, barium, strontium), or any other alkali base and combinations thereof. In an embodiment, the base can include oxides, carbonates, or other forms of Group 1 and 2 alkalis known to produce the hydroxide in solution, such as from quicklime or limestone, and a combination thereof. In an embodiment, the amount of base added to the liquid is sufficient to raise the pH to between 10 and 12.

In an embodiment, the liquid can include magnesium (e.g., less than about 5000 ppm). In an embodiment, the magnesium is not independently added to the liquid. In another embodiment, the magnesium can be independently added to the liquid. In an embodiment, the magnesium can be in the form of a compound and can include: magnesium chloride, magnesium sulfate, magnesium hydroxide, magnesium carbonate, and a combination thereof. In an embodiment, the amount of the magnesium ion can be about 1000 ppm to 20,000 ppm or about 2500 ppm to 10,000 ppm weight percent of the liquid.

In an exemplary embodiment, the solid material in the liquid can be removed from the liquid using a system such as a filtering system (e.g., membrane filter (e.g., microfiltration)), belt filter, vacuum filter, centrifuge, filterpress and the like) or other mechanism so that the liquid has a reduced amount of the contaminant. In another embodiment, the solid material can be removed using a gravity settler or a clarifier. In another embodiment, the material can be exposed to a system, such as those described above, to remove solids prior to treatment of the material.

In another exemplary embodiment, a metal (e.g., metal containing compound or metal complex) can be independently added to the liquid but is not added to the liquid with the intention to precipitate the contaminant from the liquid. For example, the metal may be an impurity in trace amounts in another component added to the liquid. In an embodiment, the metal can include the following: Fe, Al, Ti, Cu, and Mn, as well as compounds and complexes that may include these metals. In an embodiment, the metal added to the liquid can be present in the liquid at a concentration of less than about 5000 ppm, about 1000 ppm, about 500 ppm, or about 250 ppm. In an embodiment, two different metals (e.g., Fe and Cu can be added, where each is present below the amounts provided herein).

### EXAMPLES

Now having described the embodiments, in general, the examples describe some additional embodiments. While embodiments are described in connection with the examples, there is no intent to limit embodiments of the disclosure to these descriptions. On the contrary, the intent is to cover all alternatives, modifications, and equivalents included within the spirit and scope of exemplary embodiments.

### Example 1

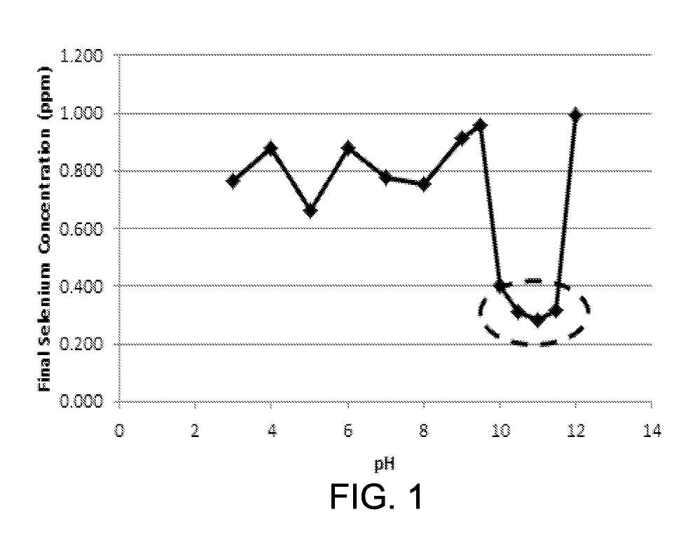

Pour 500 mL of room temperature FGD water (the average starting selenium concentration was 0.96 ppm) into a 1000 mL beaker containing a magnetic stir bar. Place the beaker on a magnetic stir plate and set to 450 RPM. While stirring, monitor pH with a pH meter. Use a 10-100 μL pipette to add 50 weight-% NaOH or 37 weight % HCl as water solutions to the FGD sample, while stirring, until the pH meter reads the desired value (between 3 and 12, as shown in FIG. 1) and remains stable. Remove the beaker from the stir plate and allow it to sit for at least 10 minutes. Attach a 500 mL vacuum filtration funnel with a 0.45-micron membrane filter to a vacuum pump. Pour the contents of the beaker into the filtration funnel, start the vacuum pump, and allow the contents to be filtered. Collect the filtrate and analyze for selenium using inductively coupled plasma mass spectrometry (ICP-MS). From the average experimental results in FIG. 1, it can be seen that the selenium removal was highest at a pH between 10 and 11.5 and the average selenium removal was about 70%.

### Example 2

Pour 200 mL of room temperature FGD water (pH 8) into two 250 mL beakers containing magnetic stir bars. Place the beakers on a magnetic stir plate and set to 450 RPM. While stirring, monitor the pH with a pH meter. Use a 10-100 μL pipette to add 50 weight-% NaOH as a water solution to one FGD sample (Beaker A), while stirring, until the pH meter reads pH 11-11.2 and remains stable. Add Ca(OH)₂ (solid powder) to the second FGD sample (Beaker B), while stirring, until the pH meter reads pH 11-11.2 and remains stable. Remove the beakers from the stir plate and allow them to sit for at least 10 minutes. Attach 500 mL vacuum filtration funnels with 0.45-micron membrane filters to two vacuum pumps. Pour the contents of the beakers into separate filtration funnels, start the vacuum pumps, and allow the contents to be filtered. Collect the filtrates and analyze for selenium and other metals using inductively coupled plasma mass spectrometry (ICP-MS) and for anions using ion chromatography (IC).

Table 1 summarizes FGD water characteristics before and after pH adjustment to 11-11.2 with NaOH or Ca(OH)₂ followed by filtration with 0.45-micron filter. Selenium removal was 84-86%.

TABLE 1
FGD water characteristics before and after the treatment.

| | | Final (Beaker | Final (Beaker |
|---|---|---|---|
| | Initial | A, filtered) | B, filtered) |
| Parameter | Concentrations in filtrate (ppm) | | |
| Selenium | 0.94 | 0.15 | 0.13 |
| Magnesium | 4800 | 100 | 95 |
| Manganese | 72 | 2 | 1 |
| Iron | 14 | 6 | 16 |
| Sulfate | 8600 | 8500 | 960 |
| Nitrate | 310 | 340 | 260 |
| Chloride | 7600 | 7300 | 7700 |

### Example 3

### Comparative Example

Pour 1000 ml of room temperature FGD water into a 1000 mL beaker containing a magnetic stir bar. Place the beaker on a magnetic stir plate and set to 450 RPM. While stirring, monitor the pH with a pH meter. Add 8.85 g Ca(OH)₂, raising the pH from 8 to about 12. Use a 1-10 mL pipette to add 5 mL of PAX XL19 (polyaluminum chloride, 45-55 weight-%, Kemira Oyj) to obtain a dose of 5000 ppm of PAX XL19. Allow to stir for 2 hours. Remove the beaker from the stir plate and allow it to sit for at least 10 minutes. Attach a 500 mL vacuum filtration funnel with a 0.45-micron membrane filter to a vacuum pump. Pour the contents of the beaker into filtration funnel, start the vacuum pump, and allow the contents to be filtered. Collect the filtrate and analyze for selenium using ICP-MS. The selenium removal was calculated and it was 74%.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to the numerical value and the measurement techniques. In addition, the phrase “about ‘x’ to ‘y’” includes “about ‘x’ to about ‘y’”.

It should be emphasized that the above-described embodiments are merely possible examples of implementations, and are merely set forth for a clear understanding of the principles of this disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

We claim at least the following:

1. A method of removing Se from a liquid, comprising:
precipitating out a solid material including Se from the liquid by changing the pH of the liquid to about 10 to 12 with the addition of a base, wherein a metal is not independently added to the liquid, wherein the metal is selected from the group consisting of: Fe, Al, Ti, Cu, and Mn; and
separating the solid material from the liquid.

2. The method of claim 1, wherein the base is selected from the group consisting of:
sodium hydroxide, lime, potassium hydroxide, calcium hydroxide, and a combination thereof.

3. The method of claim 1, further comprising: adding magnesium to the liquid.

4. The method of claim 3, wherein the magnesium is in the form of a compound selected from the group consisting of: magnesium chloride, magnesium sulfate, magnesium hydroxide, and a combination thereof.

5. The method of claim 3, wherein the amount of the magnesium is about 1000 ppm to 20,000 ppm weight percent of the liquid.

6. The method of claim 1, wherein the liquid includes magnesium.

7. The method of claim 1, wherein the pH is 11 to 12.

8. The method of claim 1, wherein the liquid is a flue gas desulfurization blowdown water.

9. A method of removing Se from a liquid, comprising:
precipitating out a solid material including Se from the liquid by changing the pH of the liquid to a pH of about 10 to 12 with the addition of a base, wherein a removing metal added to the liquid is present in the liquid at a concentration of less than about 5000 ppm, wherein the removing metal is selected from the group consisting of: Fe, Al, Ti, Cu, and Mn; and
separating the solid from the liquid.

10. The method of claim 9, wherein the base is selected from the group consisting of:
sodium hydroxide, lime, potassium hydroxide, calcium hydroxide, and a combination thereof.

11. The method of claim 9, further comprising: adding magnesium to the liquid.

12. The method of claim 11, wherein the magnesium is in the form of a compound selected from the group consisting of: magnesium chloride, and a combination thereof.

13. The method of claim 11, wherein the amount of the magnesium is about 1000 ppm to 20,000 ppm weight percent of the liquid.

14. The method of claim 9, wherein the pH is 11 to 12.

15. The method of claim 9, wherein the liquid is a flue gas desulfurization blowdown water.
